(19) United States
(12) Patent Application Publication
(10) Pub. No.: US 2019/0013981 A1
(43) Pub. Date: Jan. 10, 2019

(54) PEAK POWER REDUCTION FOR ADAPTIVE MODULATION SCHEMES

(71) Applicant: Telefonaktiebolaget LM Ericsson (publ), Stockholm (SE)

(72) Inventors: Bilel Fehri, Ottawa (CA); Pierre-Andre Laporte, Gatineau (CA)

(73) Assignee: Telefonaktiebolaget LM Ericsson (publ), Stockholm (SE)

(21) Appl. No.: 16/066,770

(22) PCT Filed: Dec. 28, 2015
(86) PCT No.: PCT/IB2015/060012

§ 371 Date: Jun. 28, 2018

(51) Int. Cl. H04L 27/26; H04L 5/00

(52) U.S. Cl. CPC H04L 27/2623; H04L 5/001

(57) ABSTRACT

Embodiments of a system and a method of operation of the system to reduce Peak-to-Average Power Ratio (PAPR) in an input signal for transmission over one or more carriers are disclosed. In some embodiments, the method of operation of the wireless transmission system comprises configuring a frequency-domain mask such that, for each subcarrier of a plurality of subcarriers of a carrier of the input signal, a value in the frequency-domain mask for the subcarrier is a function of a modulation scheme utilized in the input signal for the subcarrier. The method further comprises transforming the frequency-domain mask into a time-domain pulse and utilizing the time-domain pulse according to a pulse injection scheme to reduce a PAPR of the input signal.

### TECHNICAL FIELD

The present disclosure relates to Peak-to-Average Power Ratio (PAPR) reduction.

### BACKGROUND

Many modern wireless communications systems utilize multi-carrier transmission schemes that result in signals having a high Peak-to-Average Power Ratio (PAPR). For example, Third Generation Partnership Project (3GPP) Long Term Evolution (LTE) utilizes Orthogonal Frequency Division Multiplexing (OFDM). In the current LTE standards, a single carrier includes 76 up to 1201 subcarriers, depending on the bandwidth of the carrier. Further, in the case of carrier aggregation were multiple carriers (referred to as component carriers) are aggregated, each component carrier includes multiple subcarriers and each component carrier may include a different number of subcarriers.

One issue that arises with multi-carrier transmission schemes is that a high PAPR requires a large power amplifier back-off from maximum power, which in turn reduces the average transmit power and the power efficiency of the power amplifier. In order to address this issue, many PAPR reduction techniques (also known as Crest Factor Reduction (CFR) techniques) have been proposed to reduce the power amplifier back-off from maximum power and thereby increase the power efficiency of the power amplifier. These techniques include, for example, pulse injection techniques and clipping and windowing techniques. One example pulse injection technique is described in U.S. Pat. No. 9,014,319 B1, entitled CANCELLATION PULSE CREST FACTOR REDUCTION, which issued on Apr. 21, 2015. One example of a clipping and windowing technique is described in U.S. Pat. No. 8,724,721 B2, entitled METHOD AND APPARATUS FOR CREST FACTOR REDUCTION, which issued on May 13, 2014. Other PAPR reduction techniques for the multi-band scenario are described. For instance, in U.S. Pat. No. 8,412,124 B2, entitled MULTI-BAND PEAK POWER REDUCTION, which issued on Apr. 2, 2013.

While existing PAPR reduction techniques are beneficial, there remains a need for further improved PAPR reduction techniques.

### SUMMARY

Systems and methods relating to a subcarrier based pulse injection technique for Peak-to-Average Power Ratio (PAPR) reduction in a multi-subcarrier transmission system are disclosed. Embodiments of a method of operation of a system to reduce PAPR in an input signal for transmission over one or more carriers are disclosed. In some embodiments, the method of operation of the system comprises configuring a frequency-domain mask such that, for each subcarrier of a plurality of subcarriers of a carrier of the input signal, a value in the frequency-domain mask for the subcarrier is a function of a modulation scheme utilized in the input signal for the subcarrier. The method further comprises transforming the frequency-domain mask into a time-domain pulse and utilizing the time-domain pulse according to a pulse injection scheme to reduce a PAPR of the input signal. By taking into account the modulation schemes of the individual subcarriers, PAPR rejection is improved while also maintaining the desired noise requirements (e.g., Error Vector Magnitude (EVM)) requirements.

In some embodiments, the values in the frequency-domain mask for the subcarriers of the carrier are magnitude values, a first modulation scheme is utilized in the input signal for a first subset of the plurality of subcarriers of the carrier, and a second modulation scheme is utilized in the input signal for a second subset of the plurality of subcarriers of the carrier, the second modulation scheme being different than the first modulation scheme. Further, configuring the frequency-domain mask comprises configuring the frequency-domain mask such that magnitude values for the second subset of the plurality of subcarriers of the carrier are different than magnitude values for the first subset of the plurality of subcarriers of the carrier. In some embodiments the second modulation scheme has a more stringent noise requirement than the first modulation scheme, and the magnitude values for the second subset of the plurality of subcarriers of the carrier are less than the magnitude values for the first subset of the plurality of subcarriers of the carrier.

In some embodiments, the input signal is a single-band, single-carrier input signal to be transmitted on the carrier, and utilizing the time-domain pulse according to the pulse injection scheme to reduce the PAPR of the input signal comprises applying the time-domain pulse to a detected peak signal component of the input signal to thereby provide a peak cancellation pulse and applying the peak cancellation pulse to the input signal.

In some embodiments, the input signal is a single band, multi-carrier input signal, the frequency-domain mask is a frequency-domain mask for the carrier, the time-domain pulse is a time-domain pulse for the carrier, and the method further comprises, for each additional carrier of one or more additional carriers of the input signal, configuring a frequency-domain mask for the additional carrier such that, for each subcarrier of a plurality of subcarriers of the additional carrier, a value in the frequency-domain mask for the subcarrier of the additional carrier is a function of a modulation scheme utilized in the input signal for the subcarrier of the additional carrier. Further, the method comprises, for each additional carrier of the one or more additional carriers, transforming the frequency-domain mask for the additional carrier into a time-domain pulse for the additional carrier.

Further, in some embodiments, utilizing the time-domain pulse comprises utilizing the time-domain pulse for the carrier and the time-domain pulses for the one or more additional carriers according to the pulse injection scheme to reduce the PAPR of the input signal. Still further, in some embodiments, utilizing the time-domain pulse for the carrier and the time-domain pulses for the one or more additional carriers according to the pulse injection scheme to reduce the PAPR of the input signal comprises combining the time-domain pulse for the carrier and the time-domain pulses for the one or more additional carriers to provide a multi-carrier time-domain pulse, applying the multi-carrier time-domain pulse to a detected peak signal component of the input signal to thereby provide a peak cancellation pulse, and applying the peak cancellation pulse to the input signal.

In some embodiments, the input signal is a multi-band input signal and the carrier is in a first frequency band, and the method further comprises, for each carrier of one or more carriers in a second frequency band of the multi-band input signal, configuring a frequency-domain mask for the carrier in the second frequency band such that, for each subcarrier of a plurality of subcarriers of the carrier in the second frequency band, a value in the frequency-domain mask for the subcarrier of the carrier in the second frequency band is a function of a modulation scheme utilized in the multi-band input signal for the subcarrier of the carrier in the second frequency band. The method further comprises, for each carrier of one or more carriers in a second frequency band of the multi-band input signal, transforming the frequency-domain mask for the carrier in the second frequency band into a time-domain pulse for the carrier in the second frequency band. Further, utilizing the time-domain pulse for the carrier according to a pulse injection scheme to reduce a PAPR of the input signal comprises utilizing the time-domain pulse for the carrier in the first frequency band and the time-domain pulses for the one or more carriers in the second frequency band according to the pulse injection scheme to reduce the PAPR of the multi-band input signal.

Further, in some embodiments, the input signal comprises one or more carriers, including the carrier, for the first frequency band, and the method further comprises, for each carrier of the one or more carriers in the first frequency band, configuring a frequency-domain mask for the carrier in the first frequency band such that, for each subcarrier of a plurality of subcarriers of the carrier in the first frequency band, a value in the frequency-domain mask for the subcarrier of the carrier in the first frequency band is a function of a modulation scheme utilized in the input signal for the subcarrier of the carrier in the first frequency band; and transforming the frequency-domain mask for the carrier in the first frequency band into a time-domain pulse for the carrier in the first frequency band. Still further, utilizing the time-domain pulse for the carrier in the first frequency band and the time-domain pulses for the one or more carriers in the second frequency band according to the pulse injection scheme to reduce the PAPR of the multi-band input signal comprises utilizing the time-domain pulses for the one or more carriers in the first frequency band and the time-domain pulses for the one or more carriers in the second frequency band according to the pulse injection scheme to reduce the PAPR of the multi-band input signal.

Further, in some embodiments, utilizing the time-domain pulses for the one or more carriers in the first frequency band and the time-domain pulses for the one or more carriers in the second frequency band according to the pulse injection scheme to reduce the PAPR of the multi-band input signal comprises combining the time-domain pulses for the one or more carriers in the first frequency band to provide a time-domain pulse for the first frequency band, applying the time-domain pulse for the first frequency band to a detected peak signal component of the input signal to thereby provide a peak cancellation pulse for the first frequency band, and applying the peak cancellation pulse for the first frequency band to a first input signal for the first frequency band, the first input signal for the first frequency band being a part of the multi-band input signal. Still further, utilizing the time-domain pulses for the one or more carriers in the first frequency band and the time-domain pulses for the one or more carriers in the second frequency band according to the pulse injection scheme to reduce the PAPR of the multi-band input signal further comprises combining the time-domain pulses for the one or more carriers in the second frequency band to provide a time-domain pulse for the second frequency band, applying the time-domain pulse for the second frequency band to a detected peak signal component of the input signal to thereby provide a peak cancellation pulse for the second frequency band, and applying the peak cancellation pulse for the second frequency band to a second input signal for the second frequency band, the second input signal for the second frequency band being a part of the multi-band input signal.

In some embodiments, the input signal is single band, multi-carrier input signal, and the frequency-domain mask is a frequency-domain mask that spans all carriers of the input signal across a frequency band of the input signal. Further, configuring the frequency-domain mask comprises configuring the frequency-domain mask such that, for each subcarrier of a plurality of subcarriers of each carrier of a plurality of carriers of the input signal, a value in the frequency-domain mask for the subcarrier is a function of a modulation scheme utilized in the input signal for the subcarrier. Transforming the frequency-domain mask comprises transforming the frequency-domain mask into a multi-carrier time-domain pulse. Utilizing the time-domain pulse comprises utilizing the multi-carrier time-domain pulse according to a pulse injection scheme to reduce a PAPR of the input signal.

In some embodiments, the input signal is multi-band input signal, the frequency-domain mask is a frequency-domain mask for a first frequency band of the input signal that spans all carriers of the input signal across the first frequency band of the input signal, and transforming the frequency-domain mask comprises transforming the frequency-domain mask for the first frequency band into a time-domain pulse for the first frequency band. The method further comprises configuring a frequency-domain mask for a second frequency band of the input signal such that, for each subcarrier of a plurality of subcarriers of each carrier of one or more carriers of the input signal in the second frequency band, a value, for the subcarrier, in the frequency-domain mask for the second frequency band is a function of a modulation scheme utilized in the input signal for the subcarrier in the second frequency band, and transforming the frequency-domain mask for the second frequency band into a time-domain pulse for the second frequency band. Utilizing the time-domain pulse comprises utilizing the time-domain pulse for the first frequency band and the time-domain pulse for the second frequency band according to a pulse injection scheme to reduce a PAPR of the input signal.

In some embodiments, the method further comprises repeating, over time, the process of configuring the frequency-domain mask, transforming the frequency-domain mask into a time-domain pulse, and utilizing the time-domain pulse according to the pulse injection scheme to reduce the PAPR of the input signal. Still further, in some embodiments, the frequency-domain mask, and thus the time-domain pulse, changes over time in response to changes in the modulation schemes utilized in the input signal for the plurality of subcarriers. In some embodiments, repeating the process comprises repeating the process each transmit time interval.

Embodiments of a PAPR reduction system for a wireless transmission system are also disclosed. In some embodiments, the PAPR reduction system is adapted to operate according to any of the embodiments of the method of operation of the PAPR reduction system described above.

In some embodiments, a PAPR reduction system for a wireless transmission system comprises a peak extractor adapted to receive an input signal and extract a peak signal component of the input signal, and a subcarrier based pulse generator adapted to configure a frequency-domain mask such that, for each subcarrier of a plurality of subcarriers of the carrier, a value in the frequency-domain mask for each subcarrier of a carrier of the input signal is a function of a modulation scheme utilized in the input signal for the subcarrier. The subcarrier based pulse generator is further adapted to transform the frequency-domain mask into a time-domain pulse. The PAPR reduction system is adapted to utilize the time-domain pulse according to a pulse injection scheme to reduce a PAPR of the input signal.

In some embodiments, a PAPR reduction system for a wireless transmission system comprises a means for receiving an input signal and extracting a peak signal component of the input signal, the peak signal component of the input signal being a component of the input signal having a magnitude that is greater than a predefined threshold, a means for configuring a frequency-domain mask such that, for each subcarrier of a plurality of subcarriers of a carrier of the input signal, a value in the frequency-domain mask for the subcarrier is a function of a modulation scheme utilized in the input signal for the subcarrier, a means for transforming the frequency-domain mask into a time-domain pulse, and a means for utilizing the time-domain pulse according to a pulse injection scheme to reduce a PAPR of the input signal.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a Peak-to-Average Power Ratio (PAPR) reduction system for a single-band input signal according to some embodiments of the present disclosure;

FIGS. 2A through 2C illustrate the subcarrier based pulse generator of the PAPR reduction system of FIG. 1 in more detail according to some embodiments of the present disclosure;

FIGS. 3 and 4 illustrate simulation results for example implementations of the PAPR reduction system of FIG. 1 and the subcarrier based pulse generator of FIG. 2;

FIG. 5 illustrates the PAPR reduction system for a dual-band input signal according to some embodiments of the present disclosure;

FIGS. 6A through 6C illustrates the subcarrier based pulse generator of the PAPR reduction system of FIG. 5 for the dual-band scenario in more detail according to some embodiments of the present disclosure;

FIG. 7 is a flow chart that illustrates the operation of a PAPR reduction system according to some embodiments of the present disclosure;

FIG. 8 is a flow chart that illustrates one particular implementation of steps 100-104 of FIG. 7 according to some embodiments of the present disclosure;

FIGS. 9A through 9C illustrate step 106 of FIG. 7 in more detail for the single-band, single carrier scenario, the single-band, multi-carrier scenario, and the multi-band (single-band or multi-band) scenario, respectively, according to some embodiments of the present disclosure;

FIG. 10 is a flow chart that illustrates an adaptation procedure for a subcarrier based pulse generator according to some embodiments of the present disclosure;

FIG. 11 illustrates a cellular communications network including wireless nodes that implement a PAPR reduction system according to some embodiments of the present disclosure; and

FIG. 12 is a block diagram of a wireless node in which a PAPR reduction system is implemented according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present disclosure relates to a pulse injection technique for Peak-to-Average Power Ratio (PAPR) reduction in a multi-subcarrier transmission system, where the pulse injection technique takes into account different modulation schemes utilized for different subcarriers of a multi-subcarrier input signal to be transmitted. Before describing embodiments of the present disclosure, a brief discussion of some problems associated with conventional PAPR reduction techniques is beneficial. Using Orthogonal Frequency Division Multiplexing (OFDM) and Third Generation Partnership Project (3GPP) Long Term Evolution (LTE) as an example, depending on the transmission environment, the network load, and other considerations, different modulation schemes (e.g., Quadrature Phase Shift Keying (QPSK), 16 Quadrature Amplitude Modulation (16QAM), 64QAM, or 256QAM) are utilized for different subcarriers. The different modulation schemes have different Error Vector Magnitude (EVM) requirements (more generally different noise requirements). For example, the EVM requirement for QPSK is 17.5%, the EVM requirement for 16QAM is 12%, the EVM requirement for 64QAM is 8%, and the EVM requirement for 256QAM is between 2% and 5%.

As the LTE carrier (e.g., component carrier when carrier aggregation is used) has a high PAPR, PAPR reduction techniques are usually applied at the cost of some added distortion to the transmitted signal. Due to the different EVM requirements for different modulation schemes, the level of acceptable distortion varies depending on the modulation scheme. For example, for QPSK, the acceptable level of distortion may be 12% (as QPSK has a 17.5% margin). However, 12% added distortion for 64QAM is not acceptable.

Conventional PAPR reduction techniques treat the entire carrier as a single signal and, as such, the different subcarriers are equally distorted. As the carrier is usually formed with subcarriers having different modulation schemes and thus different distortion tolerances, the worst case subcarrier (i.e., the subcarrier for which the modulation scheme has the least distortion tolerance) will dictate the minimum acceptable distortion limit for the entire carrier (i.e., for all subcarriers). For example, if the carrier is formed using a number of 64QAM subcarriers and a number of QPSK subcarriers, conventional PAPR reduction schemes will reduce the peak power of the entire signal (i.e., all subcarrier signals) with the more restrictive distortion tolerance of 64QAM. Hence, the extra distortion tolerance margin of QPSK is not used.

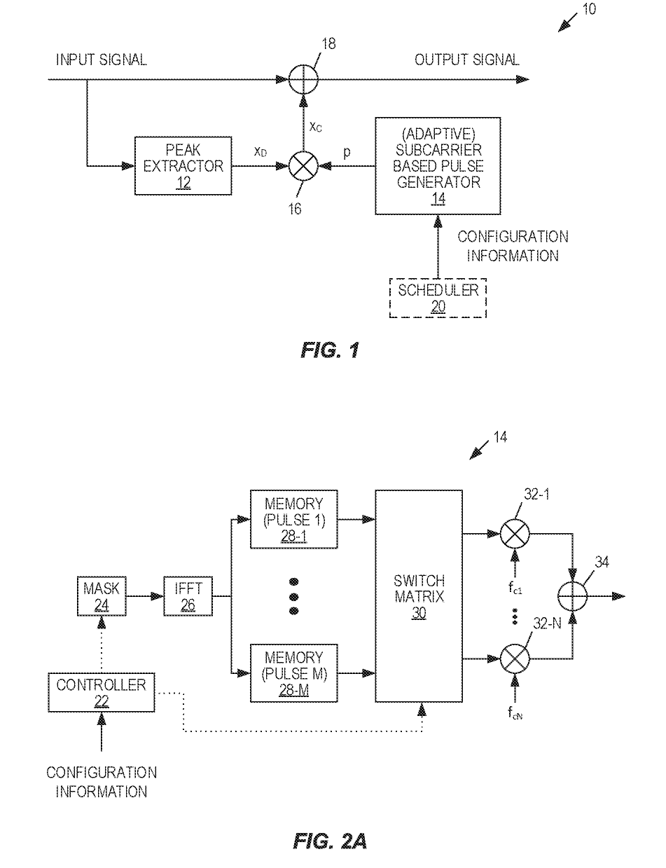

Systems and methods are described herein relating to a pulse injection PAPR reduction technique in which a signal to be transmitted on a carrier is distorted at the subcarrier level and, as such, is able to leverage the extra margin of less aggressive modulation schemes (e.g., QPSK as compared to 64QAM or 256 QAM). In this regard, FIG. 1 illustrates a PAPR reduction system 10 for a wireless transmission system (e.g., a wireless transmitter of a radio access node in a cellular communications network such as, e.g., a 3GPP LTE network) according to some embodiments of the present disclosure. Here, the PAPR reduction is for a single band, single or multi-carrier input signal. The PAPR reduction system 10 implements a pulse injection PAPR reduction technique in which the injected peak cancellation pulse is generated at the subcarrier level (e.g., according to the noise (e.g., EVM) requirements of the subcarriers on an individual basis according to the respective modulation schemes). As illustrated, the PAPR reduction system 10 includes a peak extractor 12, a subcarrier based pulse generator 14, a multiplier 16, and a combiner 18, which are implemented in hardware or a combination of hardware and software.

In operation, the peak extractor 12 detects a peak signal component of an input signal. More specifically, the peak extractor 12 compares a magnitude of the input signal (x) to a predefined threshold (T) and, based on the comparison, outputs the peak signal component (x_{D}) according to:

$${x}_{D} = \{ \begin{matrix}( abs ( x ) - T ) * exp ( 1 i * angle ( x ) ) & if abs ( x ) \geq T \\ 0 & otherwise\end{matrix} .$$

The subcarrier based pulse generator 14 obtains configuration information for the input signal that is indicative of the modulation schemes utilized in the input signal for the different subcarriers. The configuration information may include additional information such as, for example, an indication of whether the input signal is a single carrier signal or a multi-carrier signal and, if so, the number of carriers; an indication of whether the input signal is a multi-band signal (e.g., a signal having component carriers that span two or more different frequency bands) and, if so, the number of frequency bands; etc. In some embodiments, the subcarrier based pulse generator 14 receives the configuration information from a scheduler 20. The scheduler 20 may be co-located with the PAPR reduction system 10 (e.g., both the scheduler 20 and the PAPR reduction system 10 may be implemented in a radio access node such as a base station) or the scheduler 20 may be remote from the PAPR reduction system 10 (e.g., the scheduler 20 may be implemented in the cloud, whereas the PAPR reduction system 10 may be implemented at a radio access node such as a base station).

The subcarrier based pulse generator 14 uses the configuration information to generate a pulse (p) on a per-subcarrier basis. The pulse (p) is a time-domain pulse. More specifically, as described above, rather than generating the pulse (p) based on the noise (e.g., EVM) requirements of the worst case subcarrier (i.e., the subcarrier using the modulation scheme having the least distortion tolerance), the subcarrier based pulse generator 14 generates the pulse (p) on a per-subcarrier basis such that, for each subcarrier, the pulse (p) is generated based on the noise (e.g., EVM) requirement of that subcarrier, rather than the noise (e.g., EVM) requirement of some other worst case subcarrier. In this manner, unlike conventional PAPR reduction techniques, the extra distortion tolerance of modulation schemes having higher distortion tolerance is utilized to provide improved PAPR reduction.

The multiplier 16 applies the pulse (p) to the detected peak signal component (x_{D}) of the input signal to thereby provide a peak cancellation pulse (x_{C}). In other words, the detected peak signal component (x_{D}) is scaled by the pulse (p) or, conversely, the detected peak signal component (x_{D}) is a gain that is applied to the pulse (p). The combiner 18 applies the peak cancellation pulse (x_{C}) to the input signal to thereby provide an output signal (i.e., a PAPR reduced version of the input signal). In some embodiments, the combiner 18 subtracts the peak cancellation pulse (x_{C}) from the input signal to thereby reduce any peaks of the input signal while also satisfying the noise (e.g., EVM) requirements on a subcarrier basis.

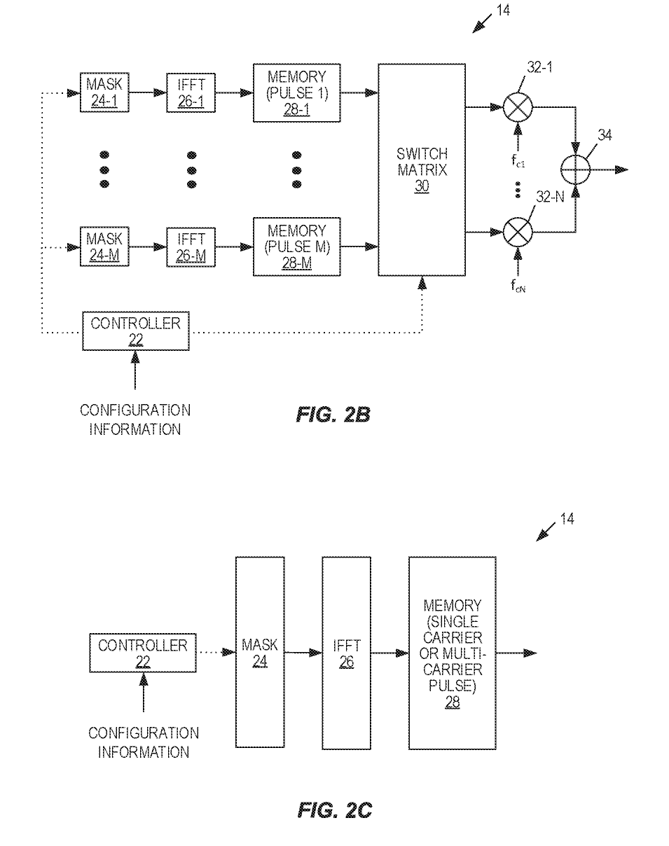

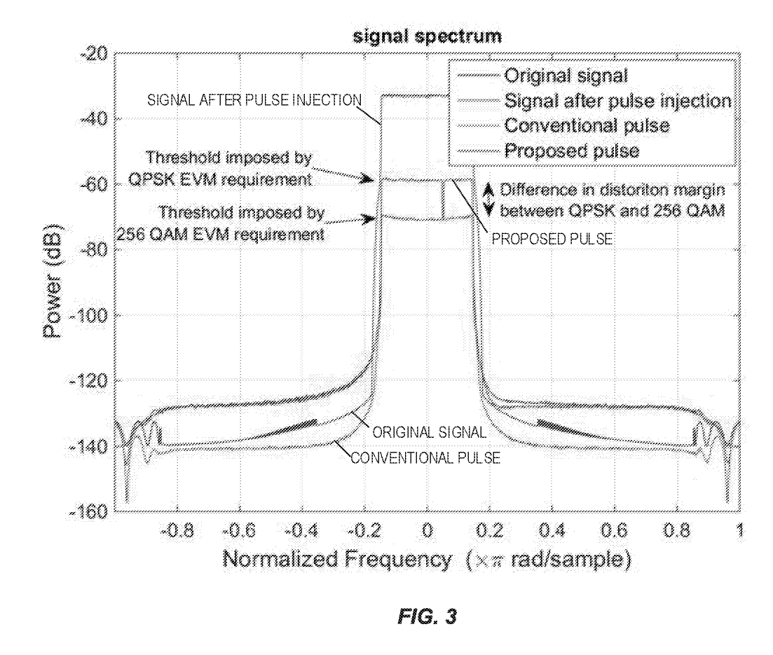

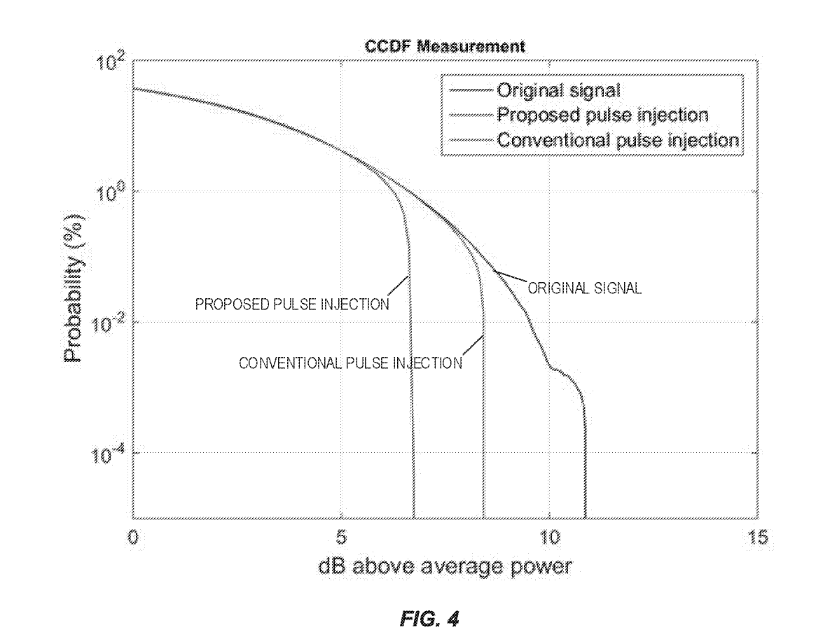

FIGS. 2A through 2C illustrate the subcarrier based pulse generator 14 of FIG. 1 in more detail according to some embodiments of the present disclosure. The embodiments of FIGS. 1 and 2A through 2C assume a single frequency band (e.g., a single carrier input signal in a single frequency band or a multi-carrier input signal in a single frequency band).

In the embodiment of FIG. 2A, the subcarrier based pulse generator 14 includes a controller 22 that configures a frequency-domain mask 24, an Inverse Fast Fourier Transform (IFFT) 26, memory 28-1 through 28-M, a switch matrix 30, mixers 32-1 through 32-N, and a combiner 34, where N 1 and N M 1. Since, in this embodiment, a single frequency band (e.g., a single carrier input signal in a single frequency band or a multi-carrier input signal in a single frequency band) is assumed, both N and M are equal to a maximum number of (component) carriers that can be configured/used for transmission. Also, in implementations in which N=1, the subcarrier based pulse generator 14 may be simplified by excluding the switch matrix 30, the mixers 32-1 through 32-N, and the combiner 34.

In operation, the controller 22 obtains the configuration information for the input signal. As discussed above, for each of one or more carriers, the configuration information includes information that indicates the modulation schemes utilized in the input signal for the subcarriers of that carrier. The configuration information may also include information that indicates the bandwidth of the carrier, power of each carrier, etc. The controller 22 configures the frequency-domain mask 24 based on the configuration information.

In this particular example, the input signal can have up to N=M component carriers (N=M≥1). For each (component) carrier, the controller 22 configures the frequency-domain mask 24 based on the configuration of modulation schemes for the subcarriers of that carrier. More specifically, the frequency-domain mask 24 defines the frequency domain content of the desired time-domain pulse (p) for the (component) carrier considering the modulation schemes utilized in the input signal for the different subcarriers of that carrier. In particular, the frequency-domain mask 24 includes a frequency bin for each subcarrier for a maximum possible carrier bandwidth. Taking into consideration the bandwidth of the carrier, at each frequency bin location in the frequency-domain mask 24 that corresponds to one of the subcarriers for that carrier, the frequency-domain mask 24 includes a value (i.e., a magnitude value) that is a function of the modulation scheme utilized in the input signal for the respective subcarrier. The magnitude values for subcarriers for which a modulation scheme having a more stringent noise (e.g., EVM) requirement (e.g., 64QAM) is utilized are less than magnitude values for subcarriers for which a modulation scheme having a less stringent noise (e.g., EVM) requirement (e.g., QPSK) is utilized. The exact values used for the magnitude values in the frequency domain-mask 24 may vary depending on the particular implementation. In some embodiments, different magnitude values for a set of possible modulation schemes for the subcarriers may be predefined and stored in memory. The controller 22 may assign those predefined magnitude values to the appropriate frequency bin locations in the frequency-domain mask 24 based on the configuration of the carrier (e.g., based on the bandwidth of the carrier and the modulation schemes utilized for the subcarriers). Note that frequency bin locations in the frequency-domain mask 24 that are outside of the bandwidth of the carrier may be set to some default value (e.g., 0).

Once the controller 22 has configured the frequency-domain mask 24 for the carrier, the IFFT 26 transforms the frequency-domain mask 24 into a time-domain pulse that is then stored in, e.g., the memory 28-1. If the input signal includes additional carriers, the process is then repeated for each additional carrier. More specifically, if the input signal includes a second carrier, the controller 22 configures the frequency-domain mask 24 for the second carrier based on the modulation schemes utilized in the input signal for the subcarriers of the second carrier. The IFFT 26 then transforms the frequency-domain mask 24 for the second carrier into a time-domain pulse for the second carrier. The time-domain pulse for the second carrier is stored in, e.g., the memory 28-2 (not shown).

Once the time-domain pulses for all of the carriers in the input signal have been generated and stored, the switch matrix 30 provides the time-domain pulses for the carriers to respective ones of the mixers 32-1 through 32-N. For example, if there are two carriers and the time-domain pulses for the two carriers are stored in the memory 28-1 and 28-2, respectively, then the switch matrix 30 may be configured (e.g., by the controller 22) such that the time-domain pulse for the first carrier is provided to, e.g., the mixer 32-1 and the time-domain pulse for the second carrier is provided to, e.g., the mixer 32-2 (not shown). The mixers 32-1 through 32-N upconvert the respective time-domain signals to the appropriate intermediate frequencies f_{c1} through f_{cN} for the respective carriers, where the frequencies f_{c1} through f_{cN} may be configured by the controller 22 depending on, e.g., the configuration information. The combiner 34 combines, or more specifically sums, the upconverted time-domain pulses for the carrier(s) to provide the (multi-carrier) time-domain pulse (p), which is then applied to the detected peak signal component (x_{D}) as described above with respect to FIG. 1. Note that if there is only one carrier in the input signal, then the time-domain pulse (p) is specifically referred to herein as a single-carrier time-domain pulse (p). However, if there are multiple carriers in the input signal, then the time-domain pulse (p) is specifically referred to herein as a multi-carrier time-domain pulse (p).

It should also be noted that the embodiment of the subcarrier based pulse generator 14 illustrated in FIG. 2A is only an example. For example, FIG. 2B illustrates an embodiment of the subcarrier based pulse generator 14 that includes multiple frequency-domain masks 24-1 through 24-M, multiple IFFTs 26-1 through 26-M, and multiple memory elements 28-1 through 28-M that enable the subcarrier based pulse generator 14 to simultaneously, or concurrently, generate the time-domain pulses for up to multiple (up to M) component carriers of the input signal. In operation, for each (component) carrier, the controller 22 configures the respective one of the frequency-domain masks 24-1 through 24-M based on the configuration of modulation schemes for the subcarriers of that carrier, as discussed above. Once the controller 22 has configured the frequency-domain masks 24-1 through 24-M for the respective carriers, the IFFTs 26-1 through 26-M transforms the frequency-domain masks 24-1 through 24-M into respective time-domain pulses that are then stored in, e.g., the respective memory elements 28-1 through 28-M. Note that there can be any number of 1 up to M carriers in this example. Once the time-domain pulses have been generated, the operation is the same as that described above with respect to FIG. 2A.

FIG. 2C illustrates another example embodiment of the subcarrier based pulse generator 14. In this example, the subcarrier based pulse generator 14 includes a single large frequency-domain mask 24 that spans all carriers across the entire frequency band. The IFFT 26 transforms the frequency-domain mask 24 into the (single carrier or multi-carrier) time domain pulse from the frequency-domain mask 24. The time-domain pulse is optionally stored in memory 28.

FIGS. 3 and 4 illustrate simulation results for example implementations of the PAPR reduction system 10 of FIG. 1 and the subcarrier based pulse generator 14 of FIGS. 2A through 2C. These simulation results are intended for illustrative purposes only and are not intended to limit the scope of the present disclosure. In the simulation, the test signal consisted of a 20 megahertz (MHz) signal comprising 1201 subcarriers, where 20 subcarriers were modulated with a 256QAM modulation scheme while the rest of the subcarriers (1181 subcarriers) were modulated with a QPSK modulation scheme. Two techniques were simulated. The first technique is the conventional pulse injection technique configured within the 256QAM EVM requirements (for all of the 1201 subcarriers). The second technique is the proposed subcarrier based pulse injection technique configured with a frequency-domain mask according to both 256QAM and QPSK distortion requirements. FIGS. 3 and 4 present, respectively, the spectrum plot and the Complementary Cumulative Distribution Function (CCDF) plot of the subcarrier based pulse injection technique versus the conventional pulse injection technique. The spectrum plot shows that the conventional pulse had a flat spectrum curve defined by the 256QAM requirement while the proposed pulse generated for the subcarrier based pulse injection technique has a region with the 256QAM requirement (same as the conventional pulse) while the rest of the subcarriers use the QPSK extra-distortion margins. As a result, the disclosed subcarrier based pulse injection technique outperformed the conventional one by about 2 decibels (dB) in the CCDF curve (FIG. 4).

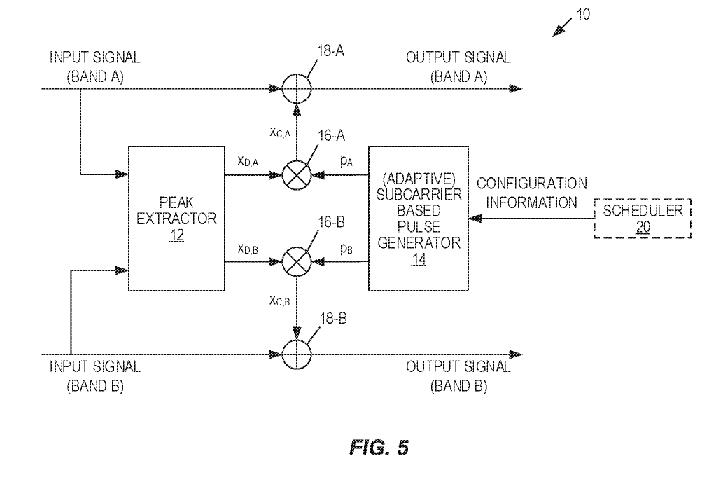

The embodiments of the PAPR reduction system 10 (FIG. 1) and the subcarrier based pulse generator 14 (FIGS. 2A through 2C) described above are for a single band, single carrier or multi-carrier input signal. However, the PAPR reduction system 10 can be extended to a multi-band, single carrier or multi-carrier input signal. In this regard, FIG. 5 illustrates the PAPR reduction system 10 for a dual-band input signal according to some embodiments of the present disclosure. In this example, the two frequency bands are referred to as frequency bands A and B. As illustrated, the PAPR reduction system 10 receives an input signal for frequency band A, and an input signal for frequency band B. Together, the input signals for frequency band A and frequency band B are referred to herein as a multi-band input signal. The input signal for frequency band A includes one or more component carriers; likewise, the input signal for frequency band B includes one or more component carriers. The number of component carriers in the input signals for frequency bands A and B may be the same or different.

The PAPR reduction system 10 of FIG. 5 operates to provide PAPR reduction for the dual-band input signal (i.e., the combination of the input signals for frequency bands A and B) to thereby provide a dual-band output signal (i.e., the combination of the output signals for frequency bands A and B). The dual-band output signal is also referred to herein as a PAPR reduced version of the dual-band input signal.

In operation, the peak extractor 12 detects an aggregated peak signal of the dual-band input signal, defined as abs(x_{A})+abs(x_{B}). More specifically, the peak extractor 12 compares a sum of the magnitudes of the input signals (x_{A} and x_{B}) for frequency bands A and B to a predefined threshold (T) and, based on the comparison, outputs a peak signal component (x_{D,A}) for frequency band A according to:

$${x}_{D , A} = \{ \begin{matrix}( abs ( {x}_{A} ) + abs ( {x}_{B} ) - T ) * exp ( 1 i * angle ( {x}_{A} ) ) & if abs ( {x}_{A} ) + abs ( {x}_{B} ) \geq T \\ 0 & otherwise\end{matrix} .$$

The subcarrier based pulse generator 14 obtains configuration information for the input signal for frequency band A that is indicative of the modulation schemes utilized in the input signal for frequency band A for the different subcarriers. The configuration information may include additional information such as, for example, an indication of whether the input signal for frequency band A is a single carrier signal or a multi-carrier signal and, if so, the number of carriers; an indication of whether the input signal is part of a multi-band signal (e.g., a signal having component carriers that span two or more different frequency bands) and, if so, the number of frequency bands; etc. In some embodiments, the subcarrier based pulse generator 14 receives the configuration information from the scheduler 20.

The subcarrier based pulse generator 14 uses the configuration information to generate a pulse (p_{A}) for frequency band A on a per-subcarrier basis. The pulse (p_{A}) is a time-domain pulse. More specifically, as described above, rather than generating the pulse (p_{A}) based on the noise (e.g., EVM) requirements of the worst case subcarrier (i.e., the subcarrier using the modulation scheme having the least distortion tolerance), the subcarrier based pulse generator 14 generates the pulse (p_{A}) on a per-subcarrier basis such that, for each subcarrier, the pulse (p_{A}) is generated based on the noise (e.g., EVM) requirement of that subcarrier, rather than the noise (e.g., EVM) requirement of some other worst case subcarrier. In this manner, unlike conventional PAPR reduction techniques, the extra distortion tolerance of modulation schemes having higher distortion tolerance is utilized to provide improved PAPR reduction. Notably, the function of the pulse (p_{A}) is to reduce the magnitude of the detected peaks in the input signal for frequency band A so that, together with a similar peak reduction for the input signal for frequency band B, the PAPR of the multi-band input signal is reduced.

The multiplier 16-A applies the pulse (p_{A}) to the detected peak signal component (x_{D,A}) of the input signal for frequency band A to thereby provide a peak cancellation pulse (x_{C,A}) for frequency band A. In other words, the detected peak signal component (x_{D,A}) is scaled by the pulse (p_{A}) or, conversely, the detected peak signal component (x_{D,A}) is a gain that is applied to the pulse (p_{A}). The combiner 18-A applies the peak cancellation pulse (x_{C,A}) to the input signal for frequency band A to thereby provide the output signal for frequency band A. In some embodiments, the combiner 18-A subtracts the peak cancellation pulse (x_{D,A}) from the input signal for frequency band A to thereby reduce any peaks of the input signal while also satisfying the noise (e.g., EVM) requirements on a subcarrier basis.

In a similar manner, the peak extractor 12 detects an aggregated peak signal of the dual-band input signal, defined as abs(x_{A})+abs(x_{B}). More specifically, the peak extractor 12 compares a sum of the magnitudes of the input signals (x_{A} and x_{B}) for frequency bands A and B to a predefined threshold (T) and, based on the comparison, outputs a peak signal component (x_{D,B}) for frequency band B according to:

$${x}_{D , B} = \{ \begin{matrix}( abs ( {x}_{A} ) + abs ( {x}_{B} ) - T ) * exp ( 1 i * angle ( {x}_{B} ) ) & if abs ( {x}_{A} ) + abs ( {x}_{B} ) \geq T \\ 0 & otherwise\end{matrix} .$$

Note that the threshold (T) is that same as that for frequency band A in this example; however, in other embodiments, the thresholds for frequency bands A and B may be different.

The subcarrier based pulse generator 14 obtains configuration information for the input signal for frequency band B that is indicative of the modulation schemes utilized in the input signal for frequency band B for the different subcarriers. The configuration information may include additional information such as, for example, an indication of whether the input signal for frequency band B is a single carrier signal or a multi-carrier signal and, if so, the number of carriers; an indication of whether the input signal is part of a multi-band signal (e.g., a signal having component carriers that span two or more different frequency bands) and, if so, the number of frequency bands; etc. In some embodiments, the subcarrier based pulse generator 14 receives the configuration information from the scheduler 20.

The subcarrier based pulse generator 14 uses the configuration information to generate a pulse (p_{B}) for frequency band B on a per-subcarrier basis. The pulse (p_{B}) is a time-domain pulse. More specifically, as described above, rather than generating the pulse (p_{B}) based on the noise (e.g., EVM) requirements of the worst case subcarrier (i.e., the subcarrier using the modulation scheme having the least distortion tolerance), the subcarrier based pulse generator 14 generates the pulse (p_{B}) on a per-subcarrier basis such that, for each subcarrier, the pulse (p_{B}) is generated based on the noise (e.g., EVM) requirement of that subcarrier, rather than the noise (e.g., EVM) requirement of some other worst case subcarrier. In this manner, unlike conventional PAPR reduction techniques, the extra distortion tolerance of modulation schemes having higher distortion tolerance is utilized to provide improved PAPR reduction. Notably, the function of the pulse (p_{B}) is to reduce the magnitude of the detected peaks in the input signal for frequency band B so that, together with a similar peak reduction for the input signal for frequency band A, the PAPR of the multi-band input signal is reduced.

The multiplier 16-B applies the pulse (p_{B}) to the detected peak signal component (x_{D,B}) of the input signal for frequency band B to thereby provide a peak cancellation pulse (x_{C,B}) for frequency band B. In other words, the detected peak signal component (x_{D,B}) is scaled by the pulse (p_{B}) or, conversely, the detected peak signal component (x_{D,B}) is a gain that is applied to the pulse (p_{B}). The combiner 18-B applies the peak cancellation pulse (x_{C,B}) to the input signal for frequency band B to thereby provide the output signal for frequency band B. In some embodiments, the combiner 18-B subtracts the peak cancellation pulse (x_{C,B}) from the input signal for frequency band B to thereby reduce any peaks of the input signal while also satisfying the noise (e.g., EVM) requirements on a subcarrier basis.

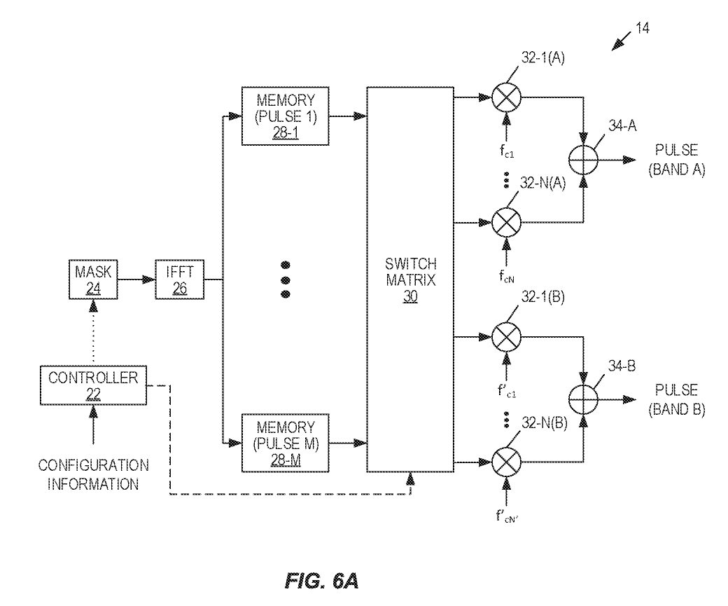

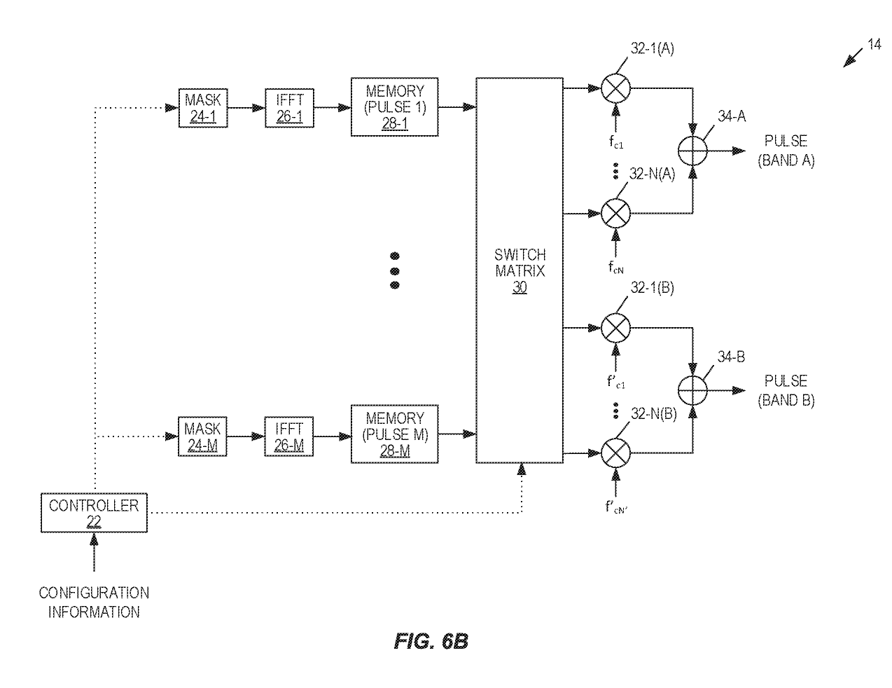

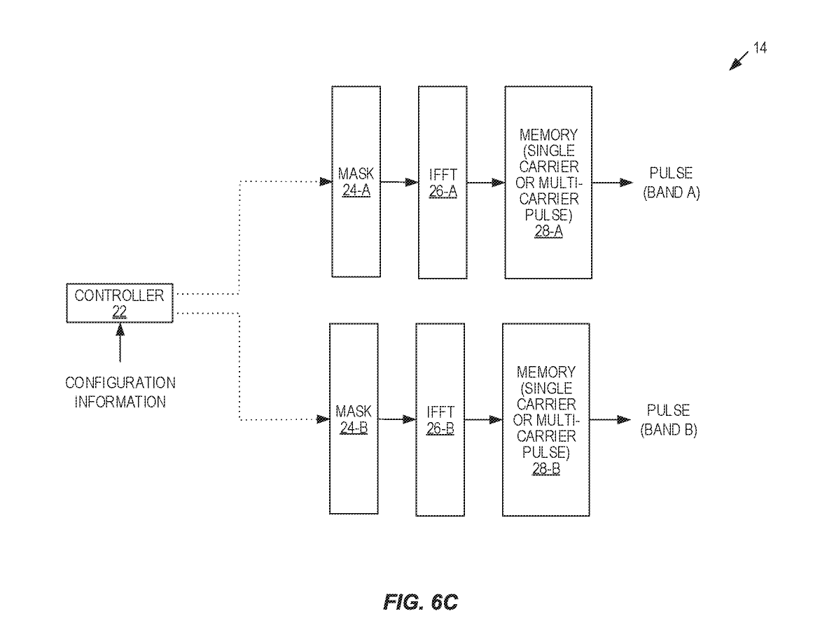

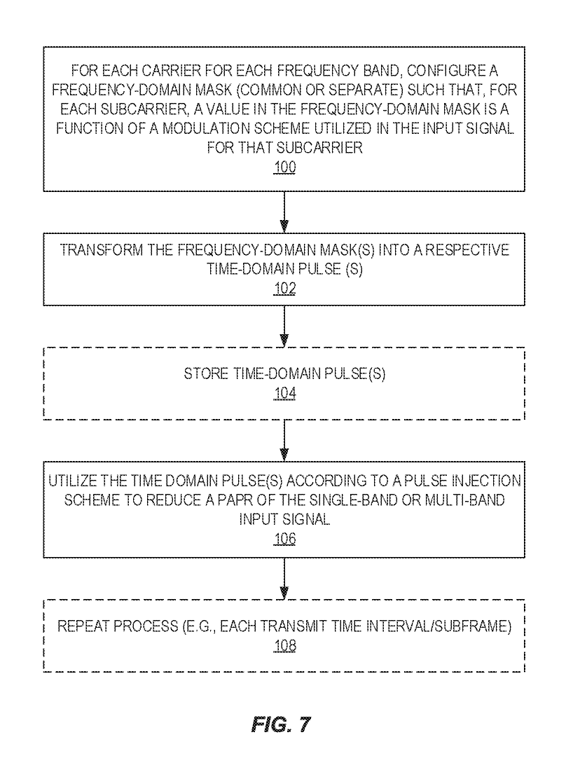

FIGS. 6A through 6C illustrate the subcarrier based pulse generator 14 of FIG. 5 for the dual-band scenario in more detail according to some embodiments of the present disclosure. In the embodiment of FIG. 6A, the subcarrier based pulse generator 14 includes the controller 22 that configures the frequency-domain mask 24, the IFFT 26, the memory 28-1 through 28-M, the switch matrix 30, the mixers 32-1(A) through 32-N(A) for frequency band A, the mixers 32-1(B) through 32-N(B) for frequency band B, the combiner 34-A for frequency band A, and the combiner 34-B for frequency band B, where N is the maximum number of carriers possible in a frequency band (i.e., the maximum number of component carriers that can be configured in a frequency band) and is greater than or equal to 1 and M is, in this particular embodiment, equal to 2N. Note that this example assumes that the maximum number of carriers that can be configured for frequency band A and frequency band B is the same; however, in other embodiments, the maximum number of carriers that can be configured for frequency band A may be different than that for frequency band B. Also, in implementations in which N=1, the subcarrier based pulse generator 14 may be simplified by excluding, e.g., the switching matrix 30, the mixers 32-1(A) through 32-N(A) and 32-1(B) through 32-N(B), and the combiners 34-A and 34-B.

In operation, the controller 22 obtains the configuration information for the multi-band input signal. As discussed above, for each of one or more carriers in each of the frequency bands A and B, the configuration information includes information that indicates the modulation schemes utilized in the multi-band input signal for the subcarriers of that carrier. The configuration information may also include information that indicates the bandwidth of the carrier, power for each carrier, etc. The controller 22 configures the frequency-domain mask 24 based on the configuration information.

In this particular example, the multi-band input signal can have up to 2×N component carriers. For frequency band A, for each (component) carrier in frequency band A, the controller 22 configures the frequency-domain mask 24 based on the configuration of modulation schemes for the subcarriers of that carrier. As described above, the frequency-domain mask 24 for the carrier defines the frequency-domain content of the desired time-domain pulse (p) for the carrier considering the modulation schemes utilized in the input signal for frequency band A for the different subcarriers of that carrier. Once the controller 22 has configured the frequency-domain mask 24 for the carrier, the IFFT 26 transforms the frequency-domain mask 24 into a time-domain pulse that is then stored in, e.g., the memory 28-1. If the input signal for frequency band A includes additional carriers, the process is then repeated for each additional carrier on frequency band A. More specifically, if the input signal for frequency band A includes a second carrier, the controller 22 configures the frequency-domain mask 24 for the second carrier in frequency band A based on the modulation schemes utilized in the input signal for the subcarriers of the second carrier. The IFFT 26 then transforms the frequency-domain mask 24 for the second carrier into a time-domain pulse for the second carrier in frequency band A. The time-domain pulse for the second carrier in frequency band A is stored in, e.g., the memory 28-2 (not shown). The same process is performed to generate and store time-domain pulses for the carriers in frequency band B.

Once the time-domain pulses for all of the carriers in both of the frequency bands A and B have been generated and stored, the switch matrix 30 provides the time-domain pulses for the carriers in frequency band A to respective ones of the mixers 32-1(A) through 32-N(A) and provides the time-domain pulses for the carriers in frequency band B to respective ones of the mixers 32-1(B) through 32-N(B). For example, if there are two carriers for frequency band A and the time-domain pulses for the two carriers in frequency band A are stored in the memories 28-1 and 28-2, respectively, then the switch matrix 30 may be configured (e.g., by the controller 22) such that the time-domain pulse for the first carrier in frequency band A is provided to, e.g., the mixer 32-1(A) and the time-domain pulse for the second carrier in frequency band A is provided to, e.g., the mixer 32-2(A) (not shown). Likewise, as an example, if there are two carriers for frequency band B and the time-domain pulses for the two carriers in frequency band B are stored in the memories 28-3 and 28-4, respectively, then the switch matrix 30 may be configured (e.g., by the controller 22) such that the time-domain pulse for the first carrier in frequency band B is provided to, e.g., the mixer 32-1(B) and the time-domain pulse for the second carrier in frequency band B is provided to, e.g., the mixer 32-2(B) (not shown).

The mixers 32-1(A) through 32-N(A) upconvert the respective time-domain pulses for frequency band A to the appropriate intermediate frequencies t_{c1} through f_{cN} for the respective carriers in frequency band A, where the frequencies f_{c1} through f_{cN} may be configured by the controller 22 depending on, e.g., the configuration information. The combiner 34-A combines, or more specifically sums, the upconverted time-domain pulses for the carrier(s) in frequency band A to provide the (multi-carrier) time-domain pulse (p_{A}), which is then applied to the detected peak signal component (x_{D,A}) as described above with respect to FIG. 5. Note that, if there is only one carrier in the input signal for frequency band A, then the time-domain pulse (p_{A}) is specifically referred to herein as a single-carrier time-domain pulse (p_{A}). However, if there are multiple carriers in the input signal, then the time-domain pulse (p_{A}) is specifically referred to herein as a multi-carrier time-domain pulse (p_{A}).

In the same way, the mixers 32-1(B) through 32-N(B) upconvert the respective time-domain pulses for frequency band B to the appropriate intermediate frequencies f′_{c1} through f′_{cN′} for the respective carriers in frequency band B, where the frequencies f′_{c1} through f′_{cN′} may be configured by the controller 22 depending on, e.g., the configuration information. The combiner 34-B combines, or more specifically sums, the upconverted time-domain pulses for the carrier(s) in frequency band B to provide the (multi-carrier) time-domain pulse (p_{B}), which is then applied to the detected peak signal component (x_{D,B}) as described above with respect to FIG. 5. Note that, if there is only one carrier in the input signal for frequency band B, then the time-domain pulse (p_{B}) is specifically referred to herein as a single-carrier time-domain pulse (p_{B}). However, if there are multiple carriers in the input signal, then the time-domain pulse (p_{B}) is specifically referred to herein as a multi-carrier time-domain pulse (p_{B}).

It should also be noted that the embodiment of the subcarrier based pulse generator 14 illustrated in FIG. 6A is only an example. For example, FIG. 6B illustrates an embodiment of the subcarrier based pulse generator 14 that includes multiple frequency-domain masks 24 and IFFTs 26 to enable the subcarrier based pulse generator 14 to simultaneously, or concurrently, generate the time-domain pulses for up to multiple (up to M) component carriers of the multi-band input signal.

For example, FIG. 6B illustrates an embodiment of the subcarrier based pulse generator 14 that includes multiple frequency-domain masks 24-1 through 24-M, multiple IFFTs 26-1 through 26-M, and multiple memory elements 28-1 through 28-M that enable the subcarrier based pulse generator 14 to simultaneously, or concurrently, generate the time-domain pulses for up to multiple (up to M) component carriers of the input signal. In operation, for each (component) carrier in each of the frequency bands A and B, the controller 22 configures the respective one of the frequency-domain masks 24-1 through 24-M based on the configuration of modulation schemes for the subcarriers of that carrier, as discussed above. Once the controller 22 has configured the frequency-domain masks 24-1 through 24-M for the respective carriers, the IFFTs 26-1 through 26-M transform the frequency-domain masks 24-1 through 24-M into respective time-domain pulses that are then stored in, e.g., the respective memory elements 28-1 through 28-M. Note that, there can be any number of 1 up to M carriers in this example. Once the time-domain pulses have been generated, the operation is the same as that described above with respect to FIG. 6A.

FIG. 6C illustrates another example embodiment of the subcarrier based pulse generator 14. In this example, the subcarrier based pulse generator 14 includes a single frequency-domain mask 24-A that spans all carriers across frequency band A and a single frequency-domain mask 24-B that spans all carriers across frequency band B. In this example, an IFFT 26-A transforms the frequency-domain mask 24-A for frequency band A into a (single carrier or multi-carrier) time domain pulse for frequency band A. Likewise, an IFFT 26-B transforms the frequency-domain mask 24-B for frequency band B into a (single carrier or multi-carrier) time domain pulse for frequency band B. The time-domain pulses are optionally stored in respective memory elements 28-A and 28-B.

FIG. 7 is a flow chart that illustrates the operation of the PAPR reduction system 10 of FIGS. 1 and 5 according to some embodiments of the present disclosure. As illustrated, for each of one or more carriers for each of one or more frequency bands, the PAPR reduction system 10 configures a frequency-domain mask 24 such that, for each subcarrier, a value in the frequency-domain mask 24 is a function of the modulation scheme utilized in the input signal for that subcarrier (step 100). As discussed above, in some embodiments, the configuration of step 100 is performed by the controller 22 based on configuration information obtained for the input signal.

Notably, as discussed above, in some embodiments, the subcarrier based pulse generator 14 iteratively configures a frequency-domain mask 24 for each carrier for each frequency band. In other embodiments, the subcarrier based pulse generator 14 simultaneously, or concurrently, configures separate frequency-domain masks 24 for multiple carriers for a single band or multi-band scenario. In both of the aforementioned embodiments, there is a separate frequency-domain mask 24 configured for each carrier. However, in other embodiments, a single large frequency-domain mask 24 is configured to span all carriers in a frequency band (or even all carriers in multiple frequency bands). In this case, the frequency-domain mask 24 is referred to herein as a common, or joint, frequency-domain mask 24 for all of the carriers.

The PAPR reduction system 10, and specifically the IFFT 26, transforms the frequency-domain mask(s) 24 into a respective time-domain pulse(s) (step 102). For example, in the embodiments of FIGS. 2A, 2B, 6A, and 6B, a separate time-domain pulse is generated for each carrier. Conversely, in the embodiments of FIGS. 2C and 6C, a single, potentially multi-carrier time-domain pulse is generated per frequency band. As discussed above, in some embodiments, the time-domain pulse(s) is(are) stored in memory (step 104). Note, however, step 104 is optional, as indicated by the dashed box in FIG. 7.

The PAPR reduction system 10 utilizes the time-domain pulse(s) according to a pulse injection scheme to reduce a PAPR of the single-band or multi-band input signal (step 106). More specifically, as discussed above with respect to FIGS. 1 and 2A through 2C, for a single-band, single carrier input signal, the time-domain pulse for the single carrier of the single-band input signal is applied to the detected peak signal component of the single-band input signal to provide a cancellation pulse. The cancellation pulse is applied to the single-band input signal to thereby provide a PAPR reduced version of the input signal. In a similar manner, for a single-band, multi-carrier input signal, in the embodiments of FIGS. 2A and 2B, the time-domain pulses for the multiple component carriers of the single-band input signal are frequency translated to the appropriate intermediate frequencies and combined to provide a multi-carrier time-domain pulse. The multi-carrier time-domain pulse for the single-band input signal is applied to the detected peak signal component of the single-band input signal to provide a cancellation pulse. The cancellation pulse is applied to the single-band input signal to thereby provide a PAPR reduced version of the input signal. Lastly, for the embodiment of FIG. 2C, the (potentially multi-carrier) time-domain pulse is generated directly from a respective frequency-domain mask 24. This time-domain pulse is applied to the detected peak signal component of the single-band input signal to provide a cancellation pulse. The cancellation pulse is applied to the single-band input signal to thereby provide a PAPR reduced version of the input signal.

For a multi-band input signal, a separate (potentially multi-carrier) time-domain pulse is generated for each frequency band of the multi-band input signal. More specifically, for each frequency band, a single-carrier or multi-carrier time-domain pulse is generated for the frequency band, depending on the number of component carriers in that frequency band. The time-domain pulse for that frequency band is applied to a detected peak signal component of an input signal for that frequency band to thereby provide a cancellation pulse for that frequency band. The cancellation pulse for that frequency band is applied to the input signal for that frequency band to thereby provide an output signal for that frequency band. The time-domain pulses generated for the multiple frequency bands are such that the PAPR of the multi-band input signal is reduced.

In some embodiments, the process of steps 100-106 is repeated over time (step 108). More specifically, in some embodiments, the subcarrier modulation schemes may vary from one transmit time interval (or subframe) to another and, as such, the process of steps 100-106 is repeated each transmit time interval. In this manner, the PAPR reduction system 10 is an adaptive system that dynamically adapts to the varying configuration (e.g., the varying subcarrier modulation scheme configuration) of the input signal. As such, in some embodiments, the subcarrier based pulse generator 14 is an adaptive subcarrier based pulse generator.

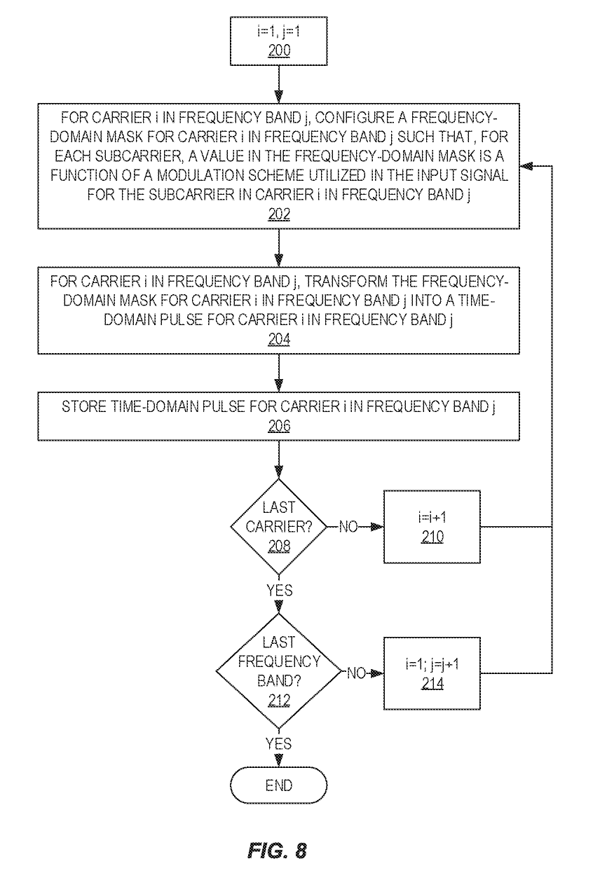

FIG. 8 is a flow chart that illustrates one particular implementation of steps 100-104 of FIG. 7 according to some embodiments of the present disclosure. In this embodiment, the time-domain pulses for one or more carriers in one or more frequency bands are generated and stored. As illustrated, a carrier index i and a frequency band index j are initialized to, in this example, a value of 1 (step 200). For carrier i in frequency band j, the PAPR reduction system 10, and in particular the controller 22 of the subcarrier based pulse generator 14, configures the frequency-domain mask 24 for carrier i in frequency band j such that, for each subcarrier, a value in the frequency-domain mask 24 is a function of the modulation scheme utilized in the input signal for the subcarrier for carrier i in frequency band j, as described above (step 202). For carrier i in frequency band j, the PAPR reduction system 10, and in particular the IFFT 26 of the subcarrier based pulse generator 14, transforms the frequency-domain mask for carrier i in frequency band j into a time-domain pulse for carrier i in frequency band j (step 204) and stores the time-domain pulse (step 206).

The PAPR reduction system 10, and in particular the controller 22, determines whether the last component carrier in frequency band j has been processed (step 208). If not, the subcarrier index i is incremented (step 210), and the process returns to step 202 to generate and store the time-domain pulse for the next subcarrier in frequency band j. Once time-domain pulses have been generated for all of the subcarriers in frequency band j (step 208; YES), the PAPR reduction system 10, and in particular the controller 22 of the subcarrier based pulse generator 14, determines whether the last frequency band has been processed (step 212). If not, the subcarrier index i is reset to a value of 1 and the frequency band index j is incremented (step 214). The process then returns to step 202 and is repeated for the next frequency band. Once time-domain pulses have been generated and stored for all carriers in all frequency bands configured for the input signal (step 212; YES), the process ends. As discussed above, the generated and stored time-domain pulses are then utilized by the PAPR reduction system 10 to reduce the PAPR of the (single-band or multi-band) input signal.

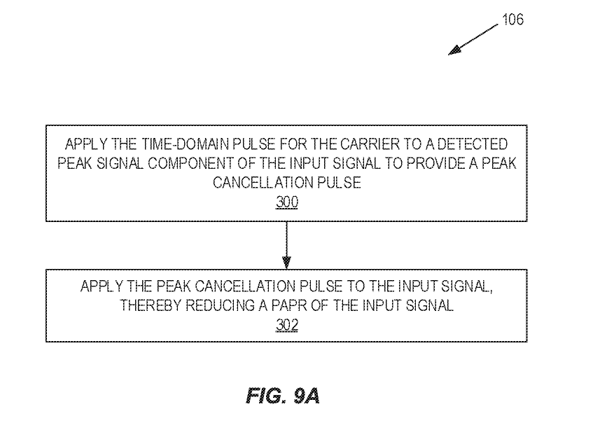

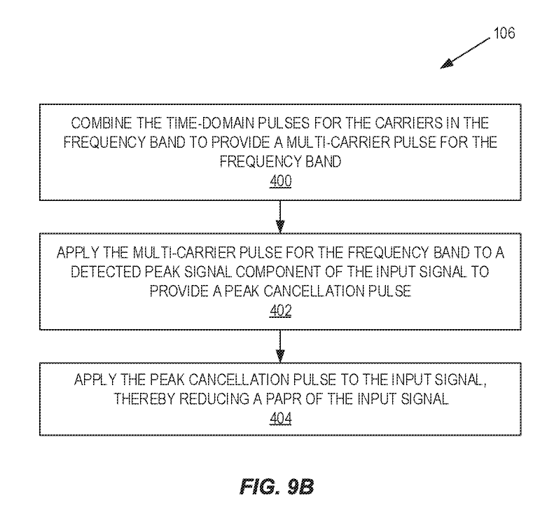

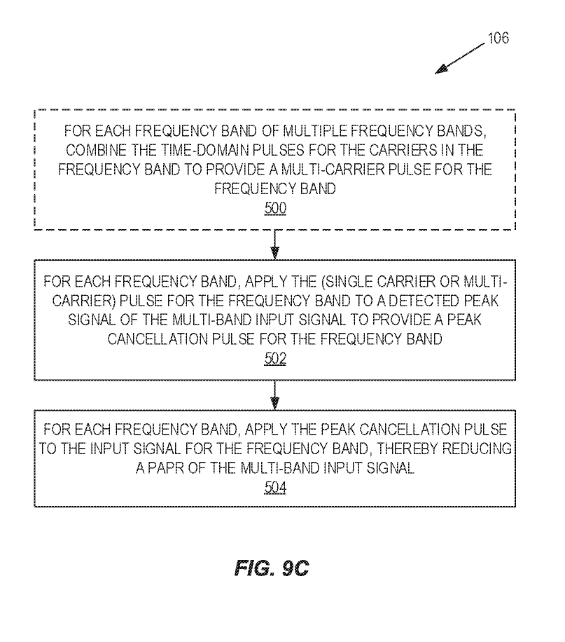

FIGS. 9A through 9C illustrate step 106 of FIG. 7 in more detail for the single-band, single carrier scenario, the single-band, multi-carrier scenario, and the multi-band scenario, respectively, according to some embodiments of the present disclosure. As illustrated in FIG. 9A, for the single-band, single carrier scenario, the PAPR reduction system 10 utilizes the generated time-domain pulse for the single-band, single carrier input signal by applying the time-domain pulse to the detected peak signal component of the input signal to provide a peak cancellation pulse (step 300). The PAPR reduction system 10 applies the peak cancellation pulse to the input signal, thereby reducing the PAPR of the input signal (step 302). Note that the process of FIG. 9A also applies to the single-band, multi-carrier scenario in which a single large frequency-domain mask 24 and a single IFFT 26 are utilized to directly generate the multi-carrier time-domain pulse. In a similar manner, FIG. 9A also applies to the dual-band scenario in which a single large frequency-domain mask 24-A/24-B and a single IFFT 26-A/26-B are utilized to directly generate the multi-carrier time-domain pulse for a particular frequency band A/B. In this case, the process of FIG. 9A would be performed for each frequency band (e.g., frequency band A and frequency band B for the dual-band scenario).

FIG. 9B illustrates step 106 of FIG. 7 in more detail for the single-band, multi-carrier scenario. In particular, FIG. 9B illustrates step 106 of FIG. 7 in more detail for the single-band, multi-carrier scenario in which separate frequency-domain masks 24 are configured for each carrier according to, e.g., the embodiment of FIG. 2A or 2B. As illustrated, once the time-domain pulses for the respective carriers are generated according to, e.g., the embodiment of FIG. 2A or 2B, the PAPR reduction system 10 utilizes the generated time-domain pulses for the single-band, multi-carrier input signal by combining the (frequency translated) time-domain pulses for the multiple carriers in the single frequency band of the input signal to provide a multi-carrier pulse (more specifically a multi-carrier time-domain pulse) (step 400). The PAPR reduction system 10 applies the multi-carrier pulse to the detected peak signal component of the input signal to provide a peak cancellation pulse (step 402). The PAPR reduction system 10 applies the peak cancellation pulse to the input signal, thereby reducing the PAPR of the input signal (step 404).

FIG. 9C, illustrates step 106 of FIG. 7 in more detail for the multi-band, single-carrier or multi-carrier scenario. In particular, FIG. 9C illustrates step 106 of FIG. 7 in more detail for the multi-band scenario in which separate frequency-domain masks 24 are configured for each carrier in each frequency band according to, e.g., the embodiment of FIG. 6A or 6B. As illustrated, in some embodiments, for each frequency band, the PAPR reduction system 10 combines the (frequency translated) time-domain pulses for the multiple carriers in the frequency band to provide a multi-carrier pulse for that frequency band (step 500). Notably, step 500 is optional (as indicated by the dashed box) for any frequency band(s) for which the input signal includes only a single carrier. In other words, if for a particular frequency band the input signal includes only a single carrier, step 500 may not be performed for that frequency band because there is only one time-domain pulse for that frequency band. For each frequency band, the PAPR reduction system 10 applies the (single carrier or multi-carrier) time-domain pulse for the frequency band to the detected peak signal component of the input signal for the multi-band input signal to provide a peak cancellation pulse for that frequency band (step 502). For each frequency band, the PAPR reduction system 10 applies the peak cancellation pulse for that frequency band to the input signal for that frequency band, thereby reducing the PAPR of the multi-band input signal (step 504).

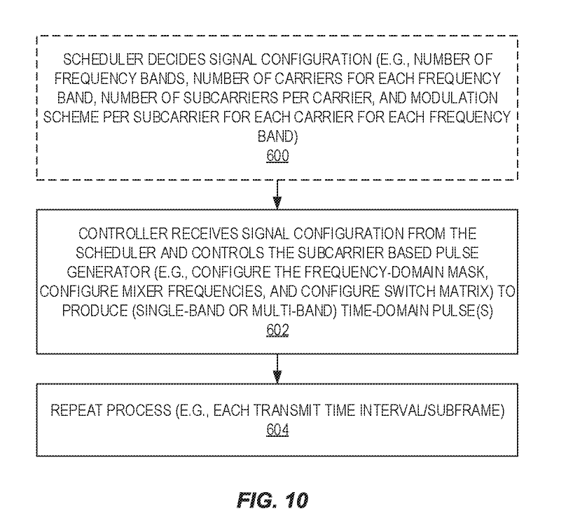

FIG. 10 is a flow chart that illustrates an adaptation procedure for the subcarrier based pulse generator 14 according to some embodiments of the present disclosure. As illustrated, in some embodiments, the scheduler 20 decides a signal configuration for the input signal, e.g., for a particular transmit time interval or subframe (step 600). The controller 22 of the subcarrier based pulse generator 14 receives the signal configuration from the scheduler 20 and controls the subcarrier based pulse generator 14 (e.g., configures the frequency-domain mask 24, configures the mixer 32 frequencies, configures the switch matrix 30) to produce the (single-band or multi-band) time-domain pulse(s) to be applied to the detected peak signal component(s) by the PAPR reduction system 10, as described above (step 602). This process is repeated over time (e.g., each transmit time interval or subframe) (step 604).

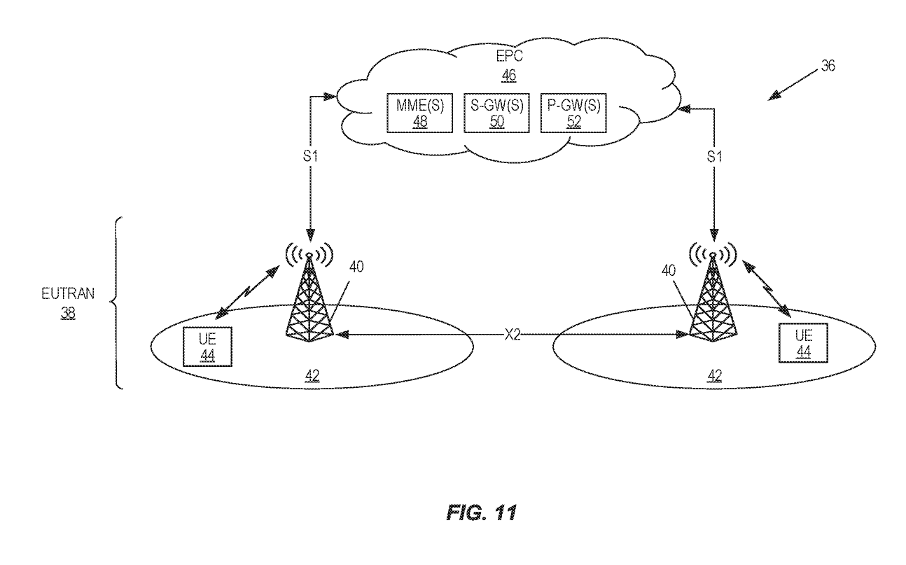

The PAPR reduction system 10 described above may be implemented in any suitable type of wireless communications system. In this regard, FIG. 11 illustrates a cellular communications network 36 including wireless nodes (e.g., Radio Access Network (RAN) nodes) that implement the PAPR reduction system 10 according to some embodiments of the present disclosure. In this example, the cellular communications network 36 is a LTE network and, as such, LTE terminology is sometimes used. However, the cellular communications network 36 is not limited to LTE. As illustrated, the cellular communications network 36 includes a Evolved Universal Terrestrial RAN (EUTRAN) 38 including enhanced or evolved Node Bs (eNBs) 40 (which may more generally be referred to herein as base stations) serving corresponding cells 42. UEs 44 (which may more generally be referred to herein as wireless devices) transmit signals to and receive signals from the eNBs 40. The eNBs 40 communicate with one another via an X2 interface. Further, the eNBs 40 are connected to an Evolved Packet Core (EPC) 46 via S1 interfaces. As will be understood by one of ordinary skill in the art, the EPC 46 includes various types of core network nodes such as, e.g., Mobility Management Entities (MMEs) 48, Serving Gateways (S-GWs) 50, and Packet Data Network Gateways (P-GWs) 52. In some embodiments, the PAPR reduction system 10 is implemented within the eNB 40. In other embodiments, the PAPR reduction system 10 is implemented within a UE 44.

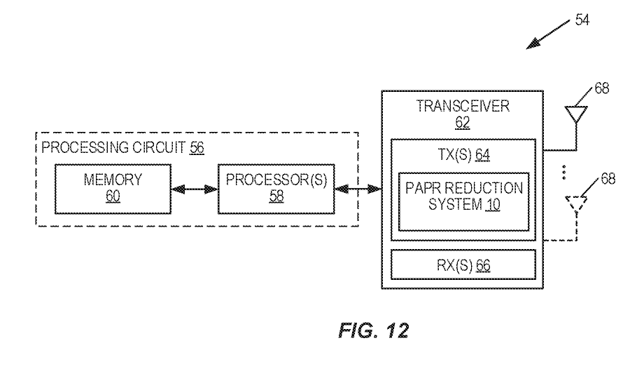

FIG. 12 is a block diagram of a wireless node 54 in which the PAPR reduction system 10 is implemented according to some embodiments of the present disclosure. The wireless node 54 may be, for example, a wireless device (e.g., the UE 44) or a radio access node (e.g., a base station such as the eNB 40). The wireless node 54 is one example of a wireless transmission system in which the PAPR reduction system 10 can be implemented. As illustrated, the wireless node 54 includes a processing circuit 56 that includes one or more processors 58 (e.g., one or more Central Processing Units (CPUs), one or more Application Specific Integrated Circuits (ASICs), one or more Field Programmable Gate Arrays (FPGAs), or the like, or any combination thereof) and memory 60. The wireless node 54 also includes a transceiver 62 including one or more transmitters 64 and one or more receivers 66 coupled to one or more antennas 68. As illustrated, in this example, the PAPR reduction system 10 is implemented within the transmitter(s) 64. Note, however, that some of the functionality of the PAPR reduction system 10 (e.g., the functionality of the controller 22) may be implemented in the processor(s) 58.

The following acronyms are used throughout this disclosure.
3GPP Third Generation Partnership Project
ASIC Application Specific Integrated Circuit
CCDF Complementary Cumulative Distribution Function
CFR Crest Factor Reduction
CPU Central Processing Unit
dB Decibel
eNB Enhanced or Evolved Node B
EPC Evolved Packet Core
EUTRAN Evolved Universal Terrestrial Radio Access Network
EVM Error Vector Magnitude
FPGA Field Programmable Gate Array
IFFT Inverse Fast Fourier Transform
LTE Long Term Evolution
MHz Megahertz
MME Mobility Management Entity
OFDM Orthogonal Frequency Division Multiplexing
PAPR Peak-to-Average Power Ratio
P-GW Packet Data Network Gateway
QAM Quadrature Amplitude Modulation
QPSK Quadrature Phase Shift Keying
RAN Radio Access Network
S-GW Serving Gateway
UE User Equipment

Those skilled in the art will recognize improvements and modifications to the embodiments of the present disclosure. All such improvements and modifications are considered within the scope of the concepts disclosed herein and the claims that follow.

1. A method of operation of a system to reduce Peak-to-Average Power Ratio, PAPR, in an input signal for transmission over one or more carriers, the method comprising:
configuring a frequency-domain mask such that, for each subcarrier of a plurality of subcarriers of a carrier of the input signal, a value in the frequency-domain mask for the subcarrier is a function of a modulation scheme utilized in the input signal for the subcarrier;
transforming the frequency-domain mask into a time-domain pulse; and
utilizing the time-domain pulse according to a pulse injection scheme to reduce a PAPR of the input signal.

2. The method of claim 1 wherein:
the values in the frequency-domain mask for the subcarriers of the carrier are magnitude values;
a first modulation scheme is utilized in the input signal for a first subset of the plurality of subcarriers of the carrier;
a second modulation scheme is utilized in the input signal for a second subset of the plurality of subcarriers of the carrier, the second modulation scheme having a different noise requirement than the first modulation scheme; and
configuring the frequency-domain mask comprises configuring the frequency-domain mask such that magnitude values for the second subset of the plurality of subcarriers of the carrier are different than magnitude values for the first subset of the plurality of subcarriers of the carrier.

3. The method of claim 2 wherein the second modulation scheme has a more stringent noise requirement than the first modulation scheme, and configuring the frequency-domain mask comprises configuring the frequency-domain mask such that magnitude values for the second subset of the plurality of subcarriers of the carrier are less than magnitude values for the first subset of the plurality of subcarriers of the carrier.

4. The method of claim 1 wherein the input signal is a single-band, single-carrier input signal to be transmitted on the carrier, and utilizing the time-domain pulse according to the pulse injection scheme to reduce the PAPR of the input signal comprises:
applying the time-domain pulse to a detected peak signal component of the input signal to thereby provide a peak cancellation pulse; and
applying the peak cancellation pulse to the input signal.

5. The method of claim 1 wherein the input signal is a single band,
multi-carrier input signal, the frequency-domain mask is a frequency-domain mask for the carrier, the time-domain pulse is a time-domain pulse for the carrier, and the method further comprises:
for each additional carrier of one or more additional carriers of the input signal:
configuring a frequency-domain mask for the additional carrier such that, for each subcarrier of a plurality of subcarriers of the additional carrier, a value in the frequency-domain mask for the subcarrier of the additional carrier is a function of a modulation scheme utilized in the input signal for the subcarrier of the additional carrier; and
transforming the frequency-domain mask for the additional carrier into a time-domain pulse for the additional carrier.

6. The method of claim 5 wherein utilizing the time-domain pulse comprises utilizing the time-domain pulse for the carrier and the time-domain pulses for the one or more additional carriers according to the pulse injection scheme to reduce the PAPR of the input signal.

7. The method of claim 6 wherein utilizing the time-domain pulse for the carrier and the time-domain pulses for the one or more additional carriers according to the pulse injection scheme to reduce the PAPR of the input signal comprises:
combining the time-domain pulse for the carrier and the time-domain pulses for the one or more additional carriers to provide a multi-carrier time-domain pulse;
applying the multi-carrier time-domain pulse to a detected peak signal component of the input signal to thereby provide a peak cancellation pulse; and
applying the peak cancellation pulse to the input signal.

8. The method of claim 1 wherein the input signal is a multi-band input signal and the carrier is in a first frequency band, and the method further comprises:
for each carrier of one or more carriers in a second frequency band of the multi-band input signal:
configuring a frequency-domain mask for the carrier in the second frequency band such that, for each subcarrier of a plurality of subcarriers of the carrier in the second frequency band, a value in the frequency-domain mask for the subcarrier of the carrier in the second frequency band is a function of a modulation scheme utilized in the multi-band input signal for the subcarrier of the carrier in the second frequency band; and
transforming the frequency-domain mask for the carrier in the second frequency band into a time-domain pulse for the carrier in the second frequency band; and
wherein utilizing the time-domain pulse for the carrier according to a pulse injection scheme to reduce a PAPR of the input signal comprises utilizing the time-domain pulse for the carrier in the first frequency band and the time-domain pulses for the one or more carriers in the second frequency band according to the pulse injection scheme to reduce the PAPR of the multi-band input signal.

9. The method of claim 8 wherein the input signal comprises one or more carriers, including the carrier, for the first frequency band, and the method further comprises:
for each carrier of the one or more carriers in the first frequency band:
configuring a frequency-domain mask for the carrier in the first frequency band such that, for each subcarrier of a plurality of subcarriers of the carrier in the first frequency band, a value in the frequency-domain mask for the subcarrier of the carrier in the first frequency band is a function of a modulation scheme utilized in the input signal for the subcarrier of the carrier in the first frequency band; and
transforming the frequency-domain mask for the carrier in the first frequency band into a time-domain pulse for the carrier in the first frequency band;
wherein utilizing the time-domain pulse for the carrier in the first frequency band and the time-domain pulses for the one or more carriers in the second frequency band according to the pulse injection scheme to reduce the PAPR of the multi-band input signal comprises utilizing the time-domain pulses for the one or more carriers in the first frequency band and the time-domain pulses for the one or more carriers in the second frequency band according to the pulse injection scheme to reduce the PAPR of the multi-band input signal.

10. The method of claim 9 wherein:
utilizing the time-domain pulses for the one or more carriers in the first frequency band and the time-domain pulses for the one or more carriers in the second frequency band according to the pulse injection scheme to reduce the PAPR of the multi-band input signal comprises:
combining the time-domain pulse for the one or more carriers in the first frequency band to provide a time-domain pulse for the first frequency band;
applying the time-domain pulse for the first frequency band to a detected peak signal component of the input signal for the first frequency band to thereby provide a peak cancellation pulse for the first frequency band;
applying the peak cancellation pulse for the first frequency band to a first input signal for the first frequency band, the first input signal for the first frequency band being a part of the multi-band input signal;
combining the time-domain pulses for the one or more carriers in the second frequency band to provide a time-domain pulse for the second frequency band;
applying the time-domain pulse for the second frequency band to a detected peak signal component of the input signal for the second frequency band to thereby provide a peak cancellation pulse for the second frequency band; and
applying the peak cancellation pulse for the second frequency band to a second input signal for the second frequency band, the second input signal for the second frequency band being a part of the multi-band input signal.

11. The method of claim 1 wherein:
the input signal is a single band, multi-carrier input signal;
the frequency-domain mask is a frequency-domain mask that spans all carriers of the input signal across a frequency band of the input signal; and:
configuring the frequency-domain mask comprises configuring the frequency-domain mask such that, for each subcarrier of a plurality of subcarriers of each carrier of a plurality of carriers of the input signal, a value in the frequency-domain mask for the subcarrier is a function of a modulation scheme utilized in the input signal for the subcarrier;
transforming the frequency-domain mask comprises transforming the frequency-domain mask into a multi-carrier time-domain pulse; and
utilizing the time-domain pulse comprises utilizing the multi-carrier time-domain pulse according to a pulse injection scheme to reduce a PAPR of the input signal.

12. The method of claim 1 wherein:
the input signal is multi-band input signal;
the frequency-domain mask is a frequency-domain mask for a first frequency band of the input signal that spans all carriers of the input signal across the first frequency band of the input signal;
transforming the frequency-domain mask comprises transforming the frequency-domain mask for the first frequency band into a time-domain pulse for the first frequency band; and
the method further comprises:
configuring a frequency-domain mask for a second frequency band of the input signal such that, for each subcarrier of a plurality of subcarriers of each carrier of one or more carriers of the input signal in the second frequency band, a value, for the subcarrier, in the frequency-domain mask for the second frequency band is a function of a modulation scheme utilized in the input signal for the subcarrier in the second frequency band; and
transforming the frequency-domain mask for the second frequency band into a time-domain pulse for the second frequency band;
wherein utilizing the time-domain pulse comprises utilizing the time-domain pulse for the first frequency band and the time-domain pulse for the second frequency band according to a pulse injection scheme to reduce a PAPR of the input signal.

13. The method of claim 1 further comprising repeating, over time, the process of configuring the frequency-domain mask, transforming the frequency-domain mask into a time-domain pulse, and utilizing the time-domain pulse according to the pulse injection scheme to reduce the PAPR of the input signal.

14. The method of claim 13 wherein the frequency-domain mask, and thus the time-domain pulse, changes over time in response to changes in the modulation schemes utilized in the input signal for the plurality of subcarriers.

15. The method of claim 13 wherein repeating the process comprises repeating the process each transmit time interval.

16. A peak-to-average power ratio, PAPR, reduction system for a wireless transmission system, comprising:
a peak extractor adapted to receive an input signal and extract a peak signal component of the input signal; and
a subcarrier based pulse generator adapted to:
configure a frequency-domain mask such that, for each subcarrier of a plurality of subcarriers of a carrier of the input signal, a value in the frequency-domain mask for the subcarrier is a function of a modulation scheme utilized in the input signal for the subcarrier; and
transform the frequency-domain mask into a time-domain pulse;
wherein the PAPR reduction system is adapted to utilize the time-domain pulse according to a pulse injection scheme to reduce a PAPR of the input signal.

17. The PAPR reduction system of claim 16 wherein:
the values in the frequency-domain mask for the subcarriers of the carrier are magnitude values;
a first modulation scheme is utilized in the input signal for a first subset of the plurality of subcarriers of the carrier;
a second modulation scheme is utilized in the input signal for a second subset of the plurality of subcarriers of the carrier, the second modulation scheme having a different noise requirement than the first modulation scheme; and
the subcarrier based pulse generator is further adapted to configure the frequency-domain mask such that magnitude values for the second subset of the plurality of subcarriers of the carrier are different than magnitude values for the first subset of the plurality of subcarriers of the carrier.

18. The method of claim 17 wherein the second modulation scheme has a more stringent noise requirement than the first modulation scheme, and configuring the frequency-domain mask comprises configuring the frequency-domain mask such that magnitude values for the second subset of the plurality of subcarriers of the carrier are less than magnitude values for the first subset of the plurality of subcarriers of the carrier.

19. The PAPR reduction system of claim 16 wherein the input signal is a single-band, single-carrier input signal to be transmitted on the carrier, and, in order to utilize the time-domain pulse to reduce the PAPR of the input signal according to the pulse injection scheme, the PAPR reduction system is adapted to:
apply the time-domain pulse to a detected peak signal component of the input signal to thereby provide a peak cancellation pulse; and
apply the peak cancellation pulse to the input signal.

20. The PAPR reduction system of claim 16 wherein the input signal is a single band, multi-carrier input signal, the frequency-domain mask is a frequency-domain mask for the carrier, the time-domain pulse is a time-domain pulse for the carrier, and the subcarrier based pulse generator is further adapted to:
for each additional carrier of the one or more additional carriers of the input signal:
configure a frequency-domain mask for the additional carrier such that, for each subcarrier of a plurality of subcarriers of the additional carrier, a value in the frequency-domain mask for the subcarrier of the additional carrier is a function of a modulation scheme utilized in the input signal for the subcarrier of the additional carrier; and
transform the frequency-domain mask for the additional carrier into a time-domain pulse for the additional carrier.

21. The PAPR reduction system of claim 20 wherein the PAPR reduction system is adapted to utilize the time-domain pulse for the carrier and the time-domain pulses for the one or more additional carriers according to the pulse injection scheme to reduce the PAPR of the input signal.

22. The PAPR reduction system of claim 21 wherein, in order to utilize the time-domain pulse for the carrier and the time-domain pulses for the one or more additional carriers according to the pulse injection scheme to reduce the PAPR of the input signal, the PAPR reduction system is further adapted to:
combine the time-domain pulse for the carrier and the time-domain pulses for the one or more additional carriers to provide a multi-carrier time-domain pulse;
apply the multi-carrier time-domain pulse to a detected peak signal component of the input signal to thereby provide a peak cancellation pulse; and
apply the peak cancellation pulse to the input signal.

23. The PAPR reduction system of claim 16 wherein the input signal is a multi-band input signal and the carrier is in a first frequency band, and the subcarrier based pulse generator is further adapted to:
for each carrier of one or more carriers in a second frequency band of the multi-band input signal:
configure a frequency-domain mask for the carrier in the second frequency band such that, for each subcarrier of a plurality of subcarriers of the carrier in the second frequency band, a value in the frequency-domain mask for the subcarrier of the carrier in the second frequency band is a function of a modulation scheme utilized in the multi-band input signal for the subcarrier of the carrier in the second frequency band; and
transform the frequency-domain mask for the carrier in the second frequency band into a time-domain pulse for the carrier in the second frequency band;
wherein, in order to utilize the time-domain pulse for the carrier according to the pulse injection scheme to reduce the PAPR of the input signal, the PAPR reduction system is further adapted to utilize the time-domain pulse for the carrier in the first frequency band and the time-domain pulses for the one or more carriers in the second frequency band according to the pulse injection scheme to reduce the PAPR of the multi-band input signal.

24. The PAPR reduction system of claim 23 wherein the input signal comprises one or more carriers, including the carrier, for the first frequency band, and the subcarrier based pulse generator is further adapted to:
for each carrier of the one or more carriers in the first frequency band:
configure a frequency-domain mask for the carrier in the first frequency band such that, for each subcarrier of a plurality of subcarriers of the carrier in the first frequency band, a value in the frequency-domain mask for the subcarrier of the carrier in the first frequency band is a function of a modulation scheme utilized in the input signal for the subcarrier of the carrier in the first frequency band; and
transform the frequency-domain mask for the carrier in the first frequency band into a time-domain pulse for the carrier in the first frequency band;
wherein, in order to utilize the time-domain pulse for the carrier in the first frequency band and the time-domain pulses for the one or more carriers in the second frequency band according to the pulse injection scheme to reduce the PAPR of the multi-band input signal, the PAPR reduction system is further adapted to utilize the time-domain pulses for the one or more carriers in the first frequency band and the time-domain pulses for the one or more carriers in the second frequency band according to the pulse injection scheme to reduce the PAPR of the multi-band input signal.

25. The PAPR reduction system of claim 24 wherein:
in order to utilize the time-domain pulses for the one or more carriers in the first frequency band and the time-domain pulses for the one or more carriers in the second frequency band according to the pulse injection scheme to reduce the PAPR of the multi-band input signal:
the subcarrier based pulse generator is further adapted to combine the time-domain pulses for the one or more carriers in the first frequency band to provide a time-domain pulse for the first frequency band and combine the time-domain pulses for the one or more carriers in the second frequency band to provide a time-domain pulse for the second frequency band; and
the PAPR reduction system is further adapted to:
apply the time-domain pulse for the first frequency band to a detected peak signal component of the input signal for the first frequency band to thereby provide a peak cancellation pulse for the first frequency band;
apply the peak cancellation pulse for the first frequency band to a first input signal for the first frequency band, the first input signal for the first frequency band being a part of the multi-band input signal;
apply the time-domain pulse for the second frequency band to a detected peak signal component of the input signal for the second frequency band to thereby provide a peak cancellation pulse for the second frequency band; and
apply the peak cancellation pulse for the second frequency band to a second input signal for the second frequency band, the second input signal for the second frequency band being a part of the multi-band input signal.

26. The PAPR reduction system of claim 16 wherein:
the input signal is single band, multi-carrier input signal;
the frequency-domain mask is a frequency-domain mask that spans all carriers of the input signal across a frequency band of the input signal;
in order to configure the frequency-domain mask, the subcarrier based pulse generator is further adapted to configure the frequency-domain mask such that, for each subcarrier of a plurality of subcarriers of each carrier of a plurality of carriers of the input signal, a value in the frequency-domain mask for the subcarrier is a function of a modulation scheme utilized in the input signal for the subcarrier;
in order to transform the frequency-domain mask, the subcarrier based pulse generator is further adapted to transform the frequency-domain mask into a multi-carrier time-domain pulse; and
in order to utilize the time-domain pulse, the PAPR reduction system is further adapted to utilize the multi-carrier time-domain pulse according to a pulse injection scheme to reduce a PAPR of the input signal.

27. The PAPR reduction system of claim 16 wherein:
the input signal is multi-band input signal;
the frequency-domain mask is a frequency-domain mask for a first frequency band of the input signal that spans all carriers of the input signal across the first frequency band of the input signal; and
in order to transform the frequency-domain mask the subcarrier based pulse generator is further adapted to transform the frequency-domain mask for the first frequency band into a time-domain pulse for the first frequency band;
the subcarrier based pulse generator being further adapted to:
configure a frequency-domain mask for a second frequency band of the input signal such that, for each subcarrier of a plurality of subcarriers of each carrier of one or more carriers of the input signal in the second frequency band, a value, for the subcarrier, in the frequency-domain mask for the second frequency band is a function of a modulation scheme utilized in the input signal for the subcarrier in the second frequency band; and
transform the frequency-domain mask for the second frequency band into a time-domain pulse for the second frequency band;
wherein, in order to utilize the time-domain pulse, the PAPR reduction system is further adapted to utilize the time-domain pulse for the first frequency band and the time-domain pulse for the second frequency band according to a pulse injection scheme to reduce a PAPR of the input signal.

28. The PAPR reduction system of claim 16 wherein the subcarrier based pulse generator is further adapted to adaptively configure the frequency-domain mask in response to changes in the modulation schemes utilized in the input signal for the plurality of subcarriers over time.

29. A peak-to-average power ratio, PAPR, reduction system for a wireless transmission system, comprising:
means for receiving an input signal and extracting a peak signal component of the input signal, the peak signal component of the input signal being a component of the input signal having a magnitude that is greater than a predefined threshold;
means for configuring a frequency-domain mask such that, for each subcarrier of a plurality of subcarriers of a carrier of the input signal, a value in the frequency-domain mask for the subcarrier is a function of a modulation scheme utilized in the input signal for the subcarrier;
means for transforming the frequency-domain mask into a time-domain pulse; and
means for utilizing the time-domain pulse according to a pulse injection scheme to reduce a PAPR of the input signal.
